(19) United States
(12) Patent Application Publication
(10) Pub. No.: US 2024/0068187 A1
(43) Pub. Date: Feb. 29, 2024

(54) SPRINKLING VEHICLE CONTROL SYSTEM, SPRINKLING VEHICLE, AND SPRINKLING VEHICLE CONTROL METHOD

(71) Applicant: Komatsu Ltd., Tokyo (JP)

(72) Inventors: Misato Maeda, Tokyo (JP); Takashi Hiranaka, Tokyo (JP); Kenta Osagawa, Tokyo (JP)

(73) Assignee: Komatsu Ltd., Tokyo (JP)

(21) Appl. No.: 18/270,774

(22) PCT Filed: Nov. 30, 2021
(86) PCT No.: PCT/JP2021/043831

§ 371 Date: Jul. 3, 2023

(30) Foreign Application Priority Data
Jan. 6, 2021 (JP) 2021-000898

(51) Int. Cl. E01H 3/02; B05B 12/08; B05B 13/00

(52) U.S. Cl. CPC E01H 3/02; B05B 12/08; B05B 13/005

(57) ABSTRACT

A sprinkling vehicle control system includes a travel control unit that switches a traveling direction of a sprinkling vehicle, and a sprinkling control unit that controls a first sprinkling spray provided at a first portion on one side in the traveling direction in the sprinkling vehicle. The sprinkling control unit controls the first sprinkling spray such that a sprinkling condition of the first sprinkling spray when the sprinkling vehicle travels to one side in the traveling direction is different from a sprinkling condition of the first sprinkling spray when the sprinkling vehicle travels to the other side in the traveling direction.

### FIELD

The present disclosure relates to a sprinkling vehicle control system, a sprinkling vehicle, and a sprinkling vehicle control method.

### BACKGROUND

As disclosed in Patent Literature 1, sprinkling is performed by a sprinkling truck at a work site.

### CITATION LIST

### Patent Literature

Patent Literature 1: US 2015/0,233,245 A

### SUMMARY

### Technical Problem

Diffusion of dust or sand at a work site is suppressed by sprinkling. On the other hand, there is a possibility that the running of a sprinkling vehicle is hindered by sprinkling water on the road surface.

An object of the present disclosure is to enable a sprinkling vehicle to smoothly travel at a work site.

### Solution to Problem

According to an aspect of the present invention, a sprinkling vehicle control system comprises: a travel control unit that switches a traveling direction of a sprinkling vehicle; and a sprinkling control unit that controls a first sprinkling spray provided at a first portion on one side in a traveling direction in the sprinkling vehicle, wherein the sprinkling control unit controls the first sprinkling spray such that a sprinkling condition of the first sprinkling spray when the sprinkling vehicle travels to the one side in the traveling direction is different from a sprinkling condition of the first sprinkling spray when the sprinkling vehicle travels to another side in the traveling direction.

### Advantageous Effects of Invention

According to the present disclosure, a sprinkling vehicle can smoothly travel at a work site.

### BRIEF DESCRIPTION OF DRAWINGS

FIG. 1 is a schematic diagram illustrating an

unmanned vehicle management system according to an embodiment.

FIG. 2 is a perspective view illustrating an unmanned sprinkling vehicle according to the embodiment.

FIG. 3 is a schematic diagram illustrating a work site according to the embodiment.

FIG. 4 is a functional block diagram illustrating an unmanned sprinkling vehicle control system according to the embodiment.

FIG. 5 is a diagram for explaining course data according to the embodiment.

FIG. 6 is a diagram for explaining an operation of the unmanned sprinkling vehicle according to the embodiment.

FIG. 7 is a diagram for explaining an operation of the unmanned sprinkling vehicle according to the embodiment.

FIG. 8 is a diagram for explaining an operation of the unmanned sprinkling vehicle according to the embodiment.

FIG. 9 is a flowchart illustrating an unmanned sprinkling vehicle control method according to the embodiment.

FIG. 10 is a diagram for explaining an operation of the unmanned sprinkling vehicle according to the embodiment.

FIG. 11 is a diagram for explaining an operation of the unmanned sprinkling vehicle according to the embodiment.

FIG. 12 is a diagram for explaining an operation of the unmanned sprinkling vehicle according to the embodiment.

### DESCRIPTION OF EMBODIMENTS

Hereinafter, embodiments according to the present disclosure will be described with reference to the drawings, but the present disclosure is not limited to the embodiments. The components of the embodiments described below can be appropriately combined. In addition, some components may not be used.

[Management System]

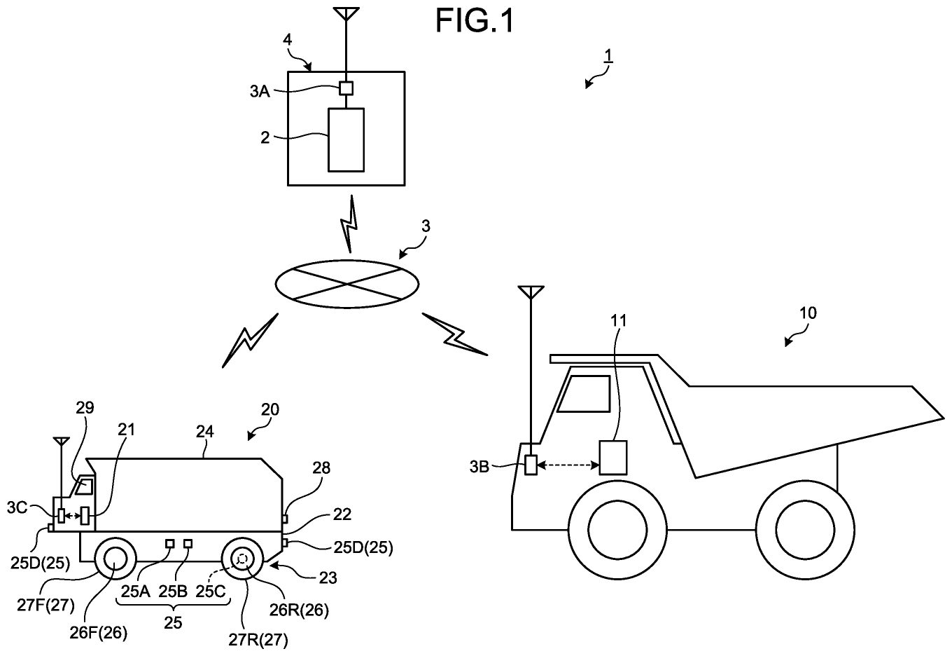

FIG. 1 is a schematic diagram illustrating an unmanned vehicle management system 1 according to an embodiment. The management system 1 manages an unmanned vehicle operating at a work site. The unmanned vehicle refers to a work vehicle that operates in an unmanned manner without depending on a driving operation by a driver. In the embodiment, the unmanned vehicle operating at the work site includes a first unmanned vehicle 10 and a second unmanned vehicle 20.

In the embodiment, the first unmanned vehicle 10 is an unmanned haul vehicle. The second unmanned vehicle 20 is an unmanned sprinkling vehicle. In the following description, the first unmanned vehicle 10 is appropriately referred to as an unmanned haul vehicle 10, and the second unmanned vehicle 20 is appropriately referred to as an unmanned sprinkling vehicle 20.

The unmanned haul vehicle 10 travels in an unmanned manner at a work site to transport a load. An unmanned dump truck is exemplified as the unmanned haul vehicle 10. An excavated object excavated at a work site is exemplified as a load to be transported to the unmanned haul vehicle 10.

The unmanned sprinkling vehicle 20 travels in the work site in an unmanned manner and sprinkles water. An unmanned sprinkling truck is exemplified as the unmanned sprinkling vehicle 20. The unmanned sprinkling vehicle 20 sprinkles water to suppress diffusion of dust or sand at the work site.

The management system 1 includes a management device 2 and a communication system 3. The management device 2 is installed in a control facility 4 of the work site. Administrators are present in the control facility 4.

The unmanned haul vehicle 10 includes a control device 11. The unmanned sprinkling vehicle 20 includes a control device 21. The management device 2, the control device 11, and the control device 21 wirelessly communicate with each other via the communication system 3. A wireless communication device 3A is connected to the management device 2. A wireless communication device 3B is connected to the control device 11. A wireless communication device 3C is connected to the control device 21. The communication system 3 includes the wireless communication device 3A, the wireless communication device 3B, and the wireless communication device 3C.

[Unmanned Sprinkling Vehicle]

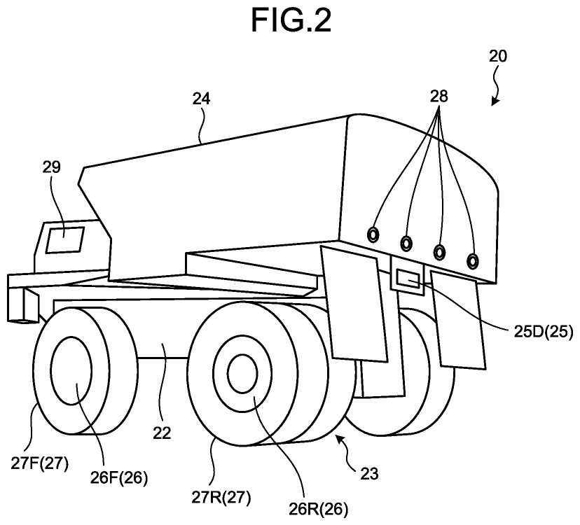

FIG. 2 is a perspective view illustrating the unmanned sprinkling vehicle 20 according to the embodiment. As illustrated in FIGS. 1 and 2, the unmanned sprinkling vehicle 20 includes the wireless communication device 3C, the control device 21, a vehicle body 22, a traveling device 23, a tank 24, a sensor system 25, and a sprinkling spray 28.

The vehicle body 22 includes a vehicle body frame. The vehicle body 22 is supported by the traveling device 23. The vehicle body 22 supports the tank 24. In the embodiment, a cab 29 is provided in the vehicle body 22. The cab 29 is provided at a front portion of the vehicle body 22. The driver can board the cab 29 and perform a driving operation of the unmanned sprinkling vehicle 20. For example, in a case of performing maintenance or inspection of the unmanned sprinkling vehicle 20, the driver performs a driving operation of the unmanned sprinkling vehicle 20. In the embodiment, the unmanned sprinkling vehicle 20 operates in an unmanned manner at least when sprinkling water at the work site. Note that the cab 29 may not be provided in the unmanned sprinkling vehicle 20.

The traveling device 23 generates a driving force for traveling the unmanned sprinkling vehicle 20. The traveling device 23 generates a braking force for decelerating or stopping the unmanned sprinkling vehicle 20. The traveling device 23 generates a steering force for turning the unmanned sprinkling vehicle 20. The traveling device 23 moves the unmanned sprinkling vehicle 20 forward or backward. The traveling device 23 includes wheels 26. Tires 27 are mounted on the wheels 26. The wheels 26 include front wheels 26F and rear wheels 26R. The front wheels 26F are steering wheels, and the rear wheels 26R are driving wheels. Both the front wheels 26F and the rear wheels 26R may be steering wheels. Both the front wheels 26F and the rear wheels 26R may be driving wheels. The front wheels 26F may be driving wheels, and the rear wheels 26R may be steering wheels. The tires 27 include front tires 27F mounted on the front wheels 26F and rear tires 27R mounted on the rear wheels 26R. When the wheels 26 rotate in a state where the tires 27 are in contact with the road surface of the work site, the unmanned sprinkling vehicle 20 travels through the work site.

The tank 24 is a member that stores water for sprinkling. At least a part of the tank 24 is disposed above the vehicle body 22.

The sensor system 25 includes a position sensor 25A, an azimuth sensor 25B, a speed sensor 25C, and an obstacle sensor 25D. The position sensor 25A detects the position of the unmanned sprinkling vehicle 20. The position of the unmanned sprinkling vehicle 20 is detected using a global navigation satellite system (GNSS). The position sensor 25A includes a GNSS receiver and detects the position of the unmanned sprinkling vehicle 20 in the global coordinate system. The azimuth sensor 25B detects the azimuth of the unmanned sprinkling vehicle 20. A gyro sensor is exemplified as the azimuth sensor 25B. The speed sensor 25C detects a traveling speed of the unmanned sprinkling vehicle 20. As the speed sensor 25C, a pulse sensor that detects the rotation of the wheel 26 is exemplified. The obstacle sensor 25D detects an obstacle around the unmanned sprinkling vehicle 20. The obstacle sensor 25D detects an obstacle in a non-contact manner. The obstacle sensor 25D is provided at least at a front portion of the unmanned sprinkling vehicle 20 and a rear portion of the unmanned sprinkling vehicle 20. The obstacle sensor 25D provided at the front portion of the unmanned sprinkling vehicle 20 detects an obstacle in front of the unmanned sprinkling vehicle 20. The obstacle sensor 25D provided at the rear portion of the unmanned sprinkling vehicle 20 detects an obstacle behind the unmanned sprinkling vehicle 20. Examples of the obstacle sensor 25D include a laser sensor (light detection and ranging (LIDAR)) and a radar sensor (radio detection and ranging (RADAR)).

The sprinkling spray 28 sprays water in the tank 24. The sprinkling spray 28 is provided at the rear portion of the unmanned sprinkling vehicle 20. The sprinkling spray 28 sprinkles water behind the unmanned sprinkling vehicle 20. In the embodiment, a plurality of sprinkling sprays 28 is provided. The plurality of sprinkling sprays is arranged at intervals in the vehicle width direction of the unmanned sprinkling vehicle 20 at the rear portion of the tank 24. The vehicle width direction refers to a direction parallel to the rotation axis of the wheels 26 when the unmanned sprinkling vehicle 20 is in a straight traveling state.

[Work Site]

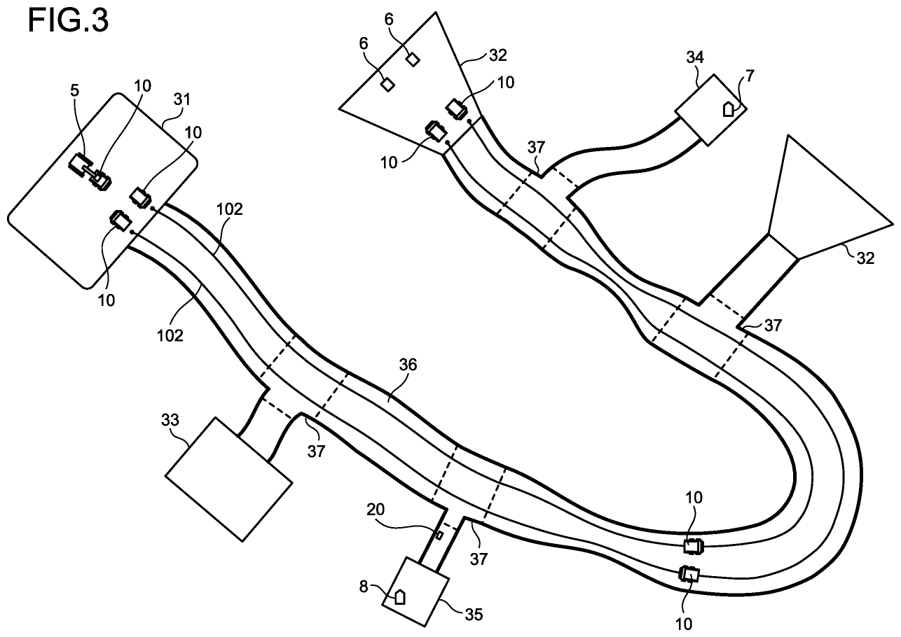

FIG. 3 is a schematic diagram illustrating a work site according to the embodiment. Examples of the work site include a mine or a quarry. The mine refers to a place or business site where minerals are mined. The quarry refers to a place or business site where stones are mined. At the work site, each of the unmanned haul vehicle 10 and the unmanned sprinkling vehicle 20 operates.

In the embodiment, the work site is a mine. Examples of the mine include a metal mine for mining metal, a non-metal mine for mining limestone, and a coal mine for mining coal.

At the work site, a loading area 31, a discharging area 32, a parking area 33, a fuel filling area 34, a water supply area 35, a travel path 36, and an intersection 37 are provided.

The loading area 31 is an area in which a loading operation of loading a load on the unmanned haul vehicle 10 is performed. In the loading area 31, a loader 5 operates. As the loader 5, an excavator is exemplified.

The discharging area 32 refers to an area where discharging work for discharging a load from the unmanned haul vehicle 10 is performed. A crusher 6 is provided in the discharging area 32.

The parking area 33 is an area where at least one of the unmanned haul vehicle 10 and the unmanned sprinkling vehicle 20 is parked.

The fuel filling area 34 is an area where at least one of the unmanned haul vehicle 10 and the unmanned sprinkling vehicle 20 is supplied with fuel. An oil feeder 7 that supplies fuel is provided in the fuel filling area 34.

The water supply area 35 is an area where the unmanned sprinkling vehicle 20 is supplied with water. In the water supply area 35, water for sprinkling is supplied to the tank 24. The water supply area 35 is provided with a water supplier 8 that supplies water to the tank 24.

The travel path 36 refers to an area where an unmanned vehicle travels toward at least one of the loading area 31, the discharging area 32, the parking area 33, the fuel filling area 34, and the water supply area 35. The travel path 36 is provided so as to connect at least the loading area 31 and the discharging area 32. In the embodiment, the travel path 36 is connected to each of the loading area 31, the discharging area 32, the parking area 33, the fuel filling area 34, and the water supply area 35.

The intersection 37 refers to an area where a plurality of travel paths 36 intersects or an area where one travel path 36 branches into a plurality of travel paths 36.

[Control System]

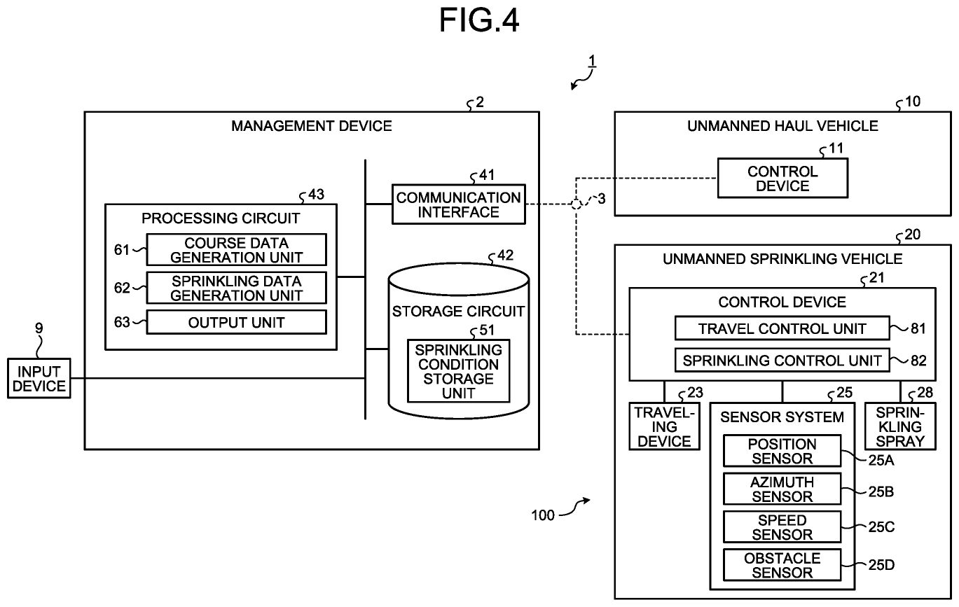

FIG. 4 is a functional block diagram illustrating a control system 100 of the unmanned sprinkling vehicle 20 according to the embodiment. The control system 100 includes the control device 21, the traveling device 23, the sensor system 25, and the sprinkling spray 28. The management system 1 includes the management device 2, the communication system 3, the control device 11, and the control device 21.

The management device 2 includes a computer system. The management device 2 is connected to an input device 9. The management device 2 includes a communication interface 41, a storage circuit 42, and a processing circuit 43.

The input device 9 is connected to the processing circuit 43. The input device 9 is operated by an administrator of the control facility 4. The input device 9 generates input data on the basis of an operation of the administrator. The input data generated by the input device 9 is input to the processing circuit 43. Examples of the input device 9 include a touch panel, a computer keyboard, a mouse, and an operation button. Note that the input device 9 may be a non-contact type input device including an optical sensor, or may be a voice input device.

The communication interface 41 is connected to the processing circuit 43. The communication interface 41 controls communication between the management device 2 and at least one of the control device 11 and the control device 21. The communication interface 41 communicates with at least one of the control device 11 and the control device 21 via the communication system 3.

The storage circuit 42 is connected to the processing circuit 43. The storage circuit 42 stores data. As the storage circuit 42, a nonvolatile memory or a volatile memory is exemplified. Examples of the nonvolatile memory include a read only memory (ROM) and a storage. Examples of the storage include a hard disk drive (HDD) and a solid state drive (SSD). As the volatile memory, a random access memory (RAM) is exemplified.

The processing circuit 43 performs arithmetic processing and control command output processing. A processor is exemplified as the processing circuit 43. Examples of the processor include a central processing unit (CPU) and a micro processing unit (MPU). A computer program is stored in the storage circuit 42. The processing circuit 43 exerts a predetermined function by acquiring and executing a computer program from the storage circuit 42.

The storage circuit 42 includes a sprinkling condition storage unit 51.

The sprinkling condition storage unit 51 stores the sprinkling condition of the sprinkling spray 28. The sprinkling condition includes at least one of execution and stop of sprinkling from the sprinkling spray 28, a sprinkling position (area information or position information) at which the sprinkling spray 28 sprinkles at the work site, and a sprinkling amount per unit time from the sprinkling spray 28. In addition, in a case where a plurality of sprinkling sprays 28 is provided in the unmanned sprinkling vehicle 20, the sprinkling condition includes the number of sprinkling sprays 28 that execute sprinkling. In addition, in a case where the sprinkling spray 28 is installed at each of a plurality of positions of the unmanned sprinkling vehicle 20, the sprinkling condition includes an installation position of the sprinkling spray 28 that executes sprinkling. The sprinkling condition is designated by the administrator. The sprinkling condition is input to the storage circuit 42 via the input device 9. The sprinkling condition storage unit 51 stores the sprinkling condition input from the input device 9.

The sprinkling condition may be determined based on the topographical condition of the work site. For example, the sprinkling condition may be determined for each of a work site on a horizontal ground, a work site on an inclined ground, and a work site on a ground whose inclination state is unknown.

The processing circuit 43 includes a course data generation unit 61, a sprinkling data generation unit 62, and an output unit 63.

The course data generation unit 61 generates course data indicating a traveling condition of the unmanned sprinkling vehicle 20. In addition, the course data generation unit 61 generates course data indicating a traveling condition of the unmanned haul vehicle 10.

The sprinkling data generation unit 62 generates sprinkling data for controlling the sprinkling spray 28. The sprinkling data generation unit 62 generates sprinkling data for controlling the sprinkling spray 28 based on the sprinkling condition stored in the sprinkling condition storage unit 51. The sprinkling data includes at least one of execution and stop of sprinkling from the sprinkling spray 28, a sprinkling position (area information or position information) at which the sprinkling spray 28 sprinkles at the work site, and a sprinkling amount per unit time from the sprinkling spray 28. In addition, in a case where a plurality of sprinkling sprays 28 is provided, the spray data includes the number of sprinkling sprays 28 that execute spraying. In addition, in a case where the sprinkling spray 28 is installed at each of a plurality of positions of the unmanned sprinkling vehicle 20, the sprinkling data includes an installation position of the sprinkling spray 28 that executes sprinkling.

The output unit 63 transmits the course data generated by the course data generation unit 61 to each of the unmanned sprinkling vehicle 20 and the unmanned haul vehicle 10. In addition, the output unit 63 transmits the sprinkling data generated by the sprinkling data generation unit 62 to the unmanned sprinkling vehicle 20. The output unit 63 causes the communication interface 41 to transmit the course data and the sprinkling data to the control device 21 of the unmanned sprinkling vehicle 20. The output unit 63 causes the communication interface 41 to transmit the course data to the control device 11 of the unmanned haul vehicle 10.

The control device 11 includes a computer system. Similarly to the management device 2, the control device 11 includes a communication interface, a storage circuit, and a processing circuit. The control device 11 causes the unmanned haul vehicle 10 to travel based on the course data transmitted from the management device 2.

The control device 21 includes a computer system. Similarly to the management device 2, the control device 21 includes a communication interface, a storage circuit, and a processing circuit. The control device 21 includes a travel control unit 81 that controls the traveling device 23 and a sprinkling control unit 82 that controls the sprinkling spray 28. The travel control unit 81 controls the traveling device 23 based on the course data transmitted from the management device 2. The sprinkling control unit 82 controls the sprinkling spray 28 based on the sprinkling data transmitted from the management device 2.

In the embodiment, the sprinkling control unit 82 controls the sprinkling spray 28 so that the sprinkling condition of the sprinkling spray 28 when the unmanned sprinkling vehicle 20 travels to one side in the traveling direction is different from the sprinkling condition of the sprinkling spray 28 when the unmanned sprinkling vehicle 20 travels to the other side in the traveling direction. The traveling direction of the unmanned sprinkling vehicle 20 means a forward direction or a backward direction. In the embodiment, traveling to one side in the traveling direction means backward traveling, and traveling to the other side in the traveling direction means forward traveling. That is, the sprinkling control unit 82 controls the sprinkling spray 28 so that the sprinkling condition of the sprinkling spray 28 when the unmanned sprinkling vehicle 20 moves backward is different from the sprinkling condition of the sprinkling spray 28 when the unmanned sprinkling vehicle 20 moves forward. The sprinkling control unit 82 controls the sprinkling spray 28 so that the sprinkling spray 28 provided at the rear portion of the unmanned sprinkling vehicle 20 meets the first sprinkling condition when the unmanned sprinkling vehicle 20 moves backward. The sprinkling control unit 82 performs control so that the sprinkling spray 28 provided at the rear portion of the unmanned sprinkling vehicle 20 meets a second sprinkling condition different from the first sprinkling condition when the unmanned sprinkling vehicle 20 moves forward.

In the embodiment, the sprinkling control unit 82 controls the sprinkling spray 28 so that the sprinkling from the sprinkling spray 28 is sprinkled when the unmanned sprinkling vehicle 20 moves forward, and the sprinkling spray 28 is stopped when the unmanned sprinkling vehicle 20 moves backward.

[Course Data]

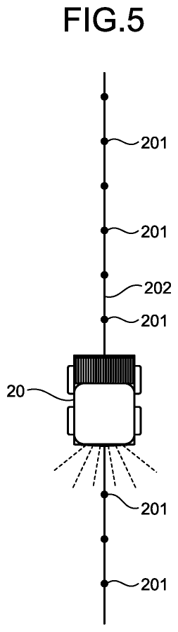

FIG. 5 is a diagram for explaining course data according to the embodiment.

The course data defines a traveling condition of the unmanned sprinkling vehicle 20. The course data includes a course point 201, a travel course 202, a target position of the unmanned sprinkling vehicle 20, a target azimuth of the unmanned sprinkling vehicle 20, a target traveling speed of the unmanned sprinkling vehicle 20, and a target traveling direction of the unmanned sprinkling vehicle 20.

A plurality of course points 201 is set at the work site. The course point 201 defines a target position of the unmanned sprinkling vehicle 20. A target azimuth, a target traveling speed, and a target traveling direction of the unmanned sprinkling vehicle 20 is set for each of the plurality of course points 201. The plurality of course points 201 is set at intervals. The interval between the course points 201 is set to, for example, 1 [m] or more and 5 [m] or less. The intervals between the course points 201 may be uniform or non-uniform.

The travel course 202 refers to a virtual line indicating a target travel path of the unmanned sprinkling vehicle 20. The travel course 202 is defined by a trajectory passing through the plurality of course points 201. The unmanned sprinkling vehicle 20 travels through the work site along the travel course 202.

The target position of the unmanned sprinkling vehicle 20 refers to a target position of the unmanned sprinkling vehicle 20 when passing through the course point 201. The target position of the unmanned sprinkling vehicle 20 may be defined in a local coordinate system of the unmanned sprinkling vehicle 20 or may be defined in a global coordinate system.

The target azimuth of the unmanned sprinkling vehicle 20 refers to a target azimuth of the unmanned sprinkling vehicle 20 when passing through the course point 201.

The target traveling speed of the unmanned sprinkling vehicle 20 refers to a target traveling speed of the unmanned sprinkling vehicle 20 when passing through the course point 201.

The target traveling direction of the unmanned sprinkling vehicle 20 refers to the target traveling direction of the unmanned sprinkling vehicle 20 when passing through the course point 201.

The travel control unit 81 controls the traveling device 23 based on the course data and the detection data of the sensor system 25. The travel control unit 81 controls the traveling device 23 so that the unmanned sprinkling vehicle 20 travels along the travel course 202 based on the detection data of the position sensor 25A and the detection data of the azimuth sensor 25B. That is, the travel control unit 81 controls the traveling device 23 so that the deviation between the detected position of the unmanned sprinkling vehicle 20 detected by the position sensor 25A when passing through the course point 201 and the target position of the unmanned sprinkling vehicle 20 set at the course point 201 becomes small. In addition, the travel control unit 81 controls the traveling device 23 so that the deviation between the detected azimuth of the unmanned sprinkling vehicle 20 detected by the azimuth sensor 25B when passing through the course point 201 and the target azimuth of the unmanned sprinkling vehicle 20 set at the course point 201 becomes small. In addition, the unmanned sprinkling vehicle 20 controls the traveling device 23 so that the unmanned sprinkling vehicle 20 travels at the target traveling speed based on the detection data of the speed sensor 25C. That is, the travel control unit 81 controls the traveling device 23 so that the deviation between the detected traveling speed of the unmanned sprinkling vehicle 20 detected by the speed sensor 25C when passing through the course point 201 and the target traveling speed of the unmanned sprinkling vehicle 20 set at the course point 201 becomes small. In addition, the travel control unit 81 controls the traveling device 23 so that the unmanned sprinkling vehicle 20 moves forward or backward based on the target traveling direction defined by the course data.

Similarly to the unmanned sprinkling vehicle 20, the unmanned haul vehicle 10 also travels based on the course data. Similar to the course data of the unmanned sprinkling vehicle 20, the course data of the unmanned haul vehicle 10 also includes a course point, a travel course 102 (see FIG. 3), a target position of the unmanned haul vehicle 10, a target azimuth of the unmanned haul vehicle 10, a target traveling speed of the unmanned haul vehicle 10, and a target traveling direction of the unmanned haul vehicle 10. The description of the unmanned haul vehicle 10 is omitted.

[Operation of Unmanned Sprinkling Vehicle]

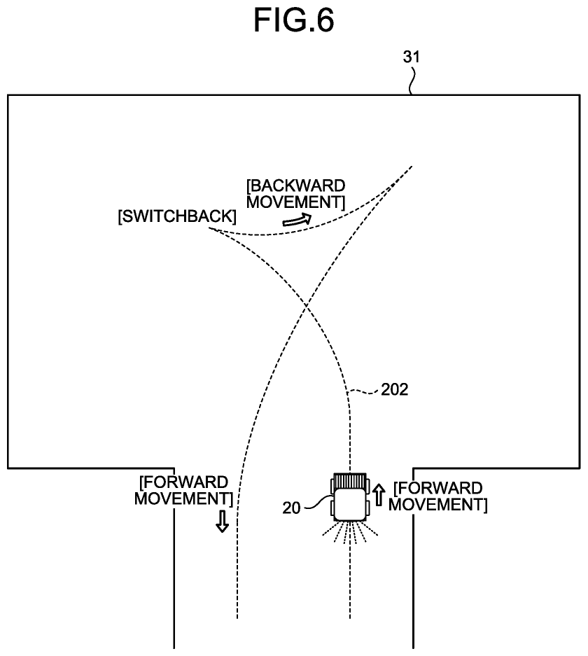

FIG. 6 is a diagram for explaining an operation of the unmanned sprinkling vehicle 20 according to the embodiment. As illustrated in FIG. 6, in the loading area 31, the travel control unit 81 may switch the traveling direction of the unmanned sprinkling vehicle 20. As described above, the traveling direction of the unmanned sprinkling vehicle 20 means a forward direction or a backward direction. That is, the travel control unit 81 may switch between forward movement and backward movement of the unmanned sprinkling vehicle 20. FIG. 6 illustrates, as an example, a state in which the unmanned sprinkling vehicle 20 is switched back. The switchback refers to an operation in which the unmanned sprinkling vehicle 20 moving forward changes its traveling direction and travels in the target direction while moving backward. The switchback is performed based on the course data.

Note that the area in which the switchback is performed is not limited to the loading area 31. The area where the switchback is performed may be at least one of the discharging area 32, the parking area 33, the fuel filling area 34, the water supply area 35, the travel path 36, and the intersection 37. In addition, the case where the unmanned sprinkling vehicle 20 is switched from forward movement to backward movement is not limited to switchback. In addition, switching from forward movement to backward movement of the unmanned sprinkling vehicle 20 may be performed on the basis of course data or may be performed not on the basis of course data.

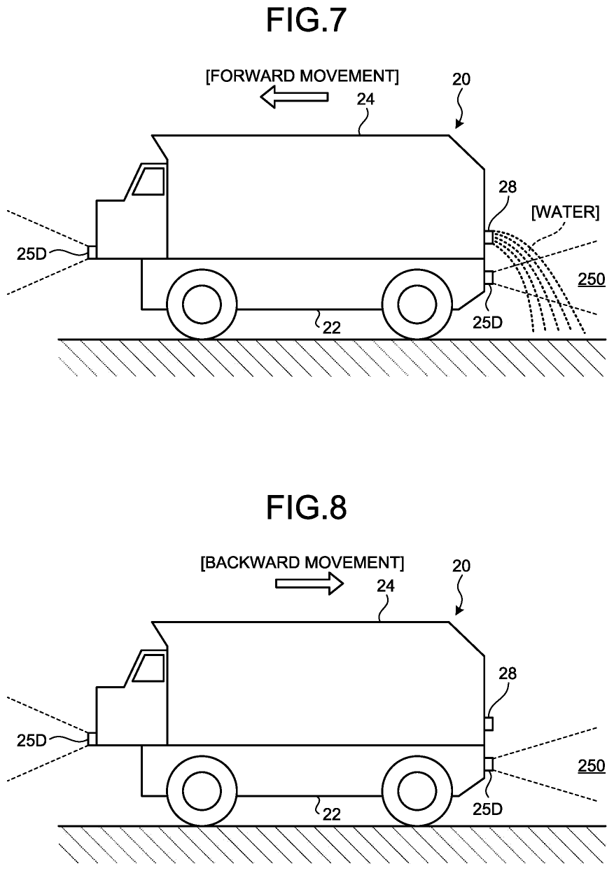

FIG. 7 is a diagram for explaining an operation of the unmanned sprinkling vehicle 20 according to the embodiment. The sprinkling spray 28 is provided at a first portion on the rear side of the unmanned sprinkling vehicle 20. That is, the sprinkling spray 28 is provided at the rear portion of the unmanned sprinkling vehicle 20. In the embodiment, the sprinkling spray 28 is disposed at the rear portion of the tank 24. As illustrated in FIG. 7, when the unmanned sprinkling vehicle 20 moves forward, water is sprinkled from the sprinkling spray 28. That is, the sprinkling control unit 82 controls the sprinkling spray 28 so that water is sprinkled from the sprinkling spray 28 when the unmanned sprinkling vehicle 20 moves forward.

The obstacle sensor 25D is provided in a second portion on the rear side of the unmanned sprinkling vehicle 20. That is, the obstacle sensor 25D is provided at the rear portion of the unmanned sprinkling vehicle 20. In the embodiment, the sprinkling spray 28 is disposed at the rear portion of the vehicle body 22. The obstacle sensor 25D is disposed below the sprinkling spray 28.

Since water is sprinkled from the sprinkling spray 28 when the unmanned sprinkling vehicle 20 is moving forward, the water sprayed from the sprinkling spray 28 is suppressed from being splashed on the obstacle sensor 25D. In addition, there is a low possibility that the unmanned sprinkling vehicle 20 moving forward interferes with an obstacle existing behind the unmanned sprinkling vehicle 20. Therefore, water sprayed from the sprinkling spray 28 is allowed to enter a detection area 250 of the obstacle sensor 25D provided at the rear portion of the unmanned sprinkling vehicle 20.

FIG. 8 is a diagram for explaining an operation of the unmanned sprinkling vehicle 20 according to the embodiment. As illustrated in FIG. 8, the sprinkling from the sprinkling spray 28 is stopped when the unmanned sprinkling vehicle 20 moves backward. That is, the sprinkling control unit 82 controls the sprinkling spray 28 so that the sprinkling from the sprinkling spray 28 is stopped when the unmanned sprinkling vehicle 20 moves backward.

Since the sprinkling from the sprinkling spray 28 is stopped when the unmanned sprinkling vehicle 20 is moving backward, the water sprayed from the sprinkling spray 28 is suppressed from splashing the obstacle sensor 25D.

In a case where the unmanned sprinkling vehicle 20 moves backward while sprinkling water from the sprinkling spray 28, the unmanned sprinkling vehicle 20 travels on the road surface immediately after being sprinkled. When the vehicle travels on the road surface immediately after being sprinkled, there is a high possibility that the tires 27 of the unmanned sprinkling vehicle 20 slip, and there is a possibility that traveling of the unmanned sprinkling vehicle 20 is hindered. In the embodiment, since the unmanned sprinkling vehicle 20 moves backward in a state where the sprinkling from the sprinkling spray 28 is stopped, the tires 27 of the unmanned sprinkling vehicle 20 are suppressed from slipping. Therefore, the unmanned sprinkling vehicle 20 can travel smoothly.

As described above, in a case where the sprinkling spray 28 is provided at the rear portion of the unmanned sprinkling vehicle 20 and the sprinkling spray 28 is sprinkled toward the rear of the unmanned sprinkling vehicle 20, the sprinkling control unit 82 controls the sprinkling spray 28 so that water is sprinkled from the sprinkling spray 28 in a case where the unmanned sprinkling vehicle 20 moves forward and the sprinkling from the sprinkling spray 28 is stopped in a case where the unmanned sprinkling vehicle 20 moves backward. As a result, the tires 27 are suppressed from slipping when the unmanned sprinkling vehicle 20 moves backward, and the unmanned sprinkling vehicle 20 can smoothly move backward.

In addition, when the water sprayed from the sprinkling spray 28 is splashed on the obstacle sensor 25D provided at the rear portion of the unmanned sprinkling vehicle 20 or enters the detection area 250 of the obstacle sensor 25D, the detection accuracy of the obstacle sensor 25D may be deteriorated. In the embodiment, when the unmanned sprinkling vehicle 20 moves backward, it is suppressed that the water sprayed from the sprinkling spray 28 splashes the obstacle sensor 25D provided at the rear portion of the unmanned sprinkling vehicle 20 or enters the detection area 250 of the obstacle sensor 25D, so that a decrease in detection accuracy of the obstacle sensor 25D is suppressed.

The sprinkling control unit 82 can switch between execution and stop of sprinkling from the sprinkling spray 28 based on the course data of the unmanned sprinkling vehicle 20. As described above, the course data defines a target traveling direction of the unmanned sprinkling vehicle 20. As described with reference to FIG. 7, in a case where the switching from the forward movement to the backward movement of the unmanned sprinkling vehicle 20 is executed on the basis of the course data, the sprinkling control unit 82 can switch between the execution of the sprinkling from the sprinkling spray 28 and the stop of the sprinkling on the basis of the course data of the unmanned sprinkling vehicle 20.

The sprinkling control unit 82 may switch between execution and stop of sprinkling from the sprinkling spray 28 based on, for example, the rotation direction of the wheel 26. For example, in a case where the speed sensor 25C has a function of detecting the rotation direction of the wheel 26, the sprinkling control unit 82 may switch between execution and stop of sprinkling from the sprinkling spray 28 based on the detection data of the speed sensor 25C. That is, the sprinkling control unit 82 controls the sprinkling spray 28 so that the sprinkling from the sprinkling spray 28 is executed in a case where it is determined that the wheel 26 is rotating forward for the forward movement of the unmanned sprinkling vehicle 20 based on the detection data of the speed sensor 25C. The sprinkling control unit 82 controls the sprinkling spray 28 so that the sprinkling from the sprinkling spray 28 is stopped in a case where it is determined that the wheels 26 are rotating backward for backward movement of the unmanned sprinkling vehicle 20 based on the detection data of the speed sensor 25C.

[Control Method]

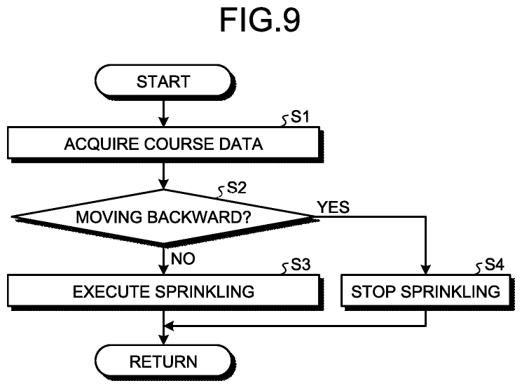

FIG. 9 is a flowchart illustrating a control method of the unmanned sprinkling vehicle 20 according to the embodiment. The travel control unit 81 acquires the course data transmitted from the management device 2. The travel control unit 81 controls the traveling device 23 based on the course data. In a case of acquiring course data indicating a traveling condition for moving the unmanned sprinkling vehicle 20 forward, the travel control unit 81 controls the traveling device 23 so that the unmanned sprinkling vehicle 20 moves forward. In a case of acquiring course data indicating a traveling condition for moving the unmanned sprinkling vehicle 20 backward, the travel control unit 81 controls the traveling device 23 so that the unmanned sprinkling vehicle 20 moves backward.

The sprinkling control unit 82 acquires the course data transmitted from the management device 2 (Step S1).

The sprinkling control unit 82 determines whether or not the course data transmitted from the management device 2 is course data indicating a traveling condition for moving the unmanned sprinkling vehicle 20 backward. That is, the sprinkling control unit 82 determines whether the unmanned sprinkling vehicle 20 moves backward (Step S2).

In Step S2, in a case where it is determined that the unmanned sprinkling vehicle 20 moves forward (Step S2: No), the sprinkling control unit 82 controls the sprinkling spray 28 so that the sprinkling from the sprinkling spray 28 is executed (Step S3).

In Step S2, in a case where it is determined that the unmanned sprinkling vehicle 20 moves backward (Step S2: Yes), the sprinkling control unit 82 controls the sprinkling spray 28 so that the sprinkling from the sprinkling spray 28 is stopped (Step S4).

Note that the sprinkling control unit 82 may switch between the sprinkling from the sprinkling spray 28 and the stop of the sprinkling, not based on the course data. For example, as described above, the sprinkling control unit 82 may switch between execution and stop of sprinkling from the sprinkling spray 28 based on the rotation direction of the wheels 26.

[Effects]

As described above, according to the embodiment, in a case where the sprinkling spray 28 is provided at the rear portion of the unmanned sprinkling vehicle 20 and the sprinkling spray 28 sprays toward the rear of the unmanned sprinkling vehicle 20, the sprinkling control unit 82 controls the sprinkling spray 28 so that the spray is sprinkled from the sprinkling spray 28 when the unmanned sprinkling vehicle 20 moves forward and the spray from the sprinkling spray 28 is stopped when the unmanned sprinkling vehicle 20 moves backward. As a result, the tires 27 are suppressed from slipping when the unmanned sprinkling vehicle 20 moves backward, and the unmanned sprinkling vehicle 20 can travel smoothly.

In addition, when the unmanned sprinkling vehicle 20 moves backward, a decrease in detection accuracy of the obstacle sensor 25D provided at the rear portion of the unmanned sprinkling vehicle 20 is suppressed.

### Other Embodiments

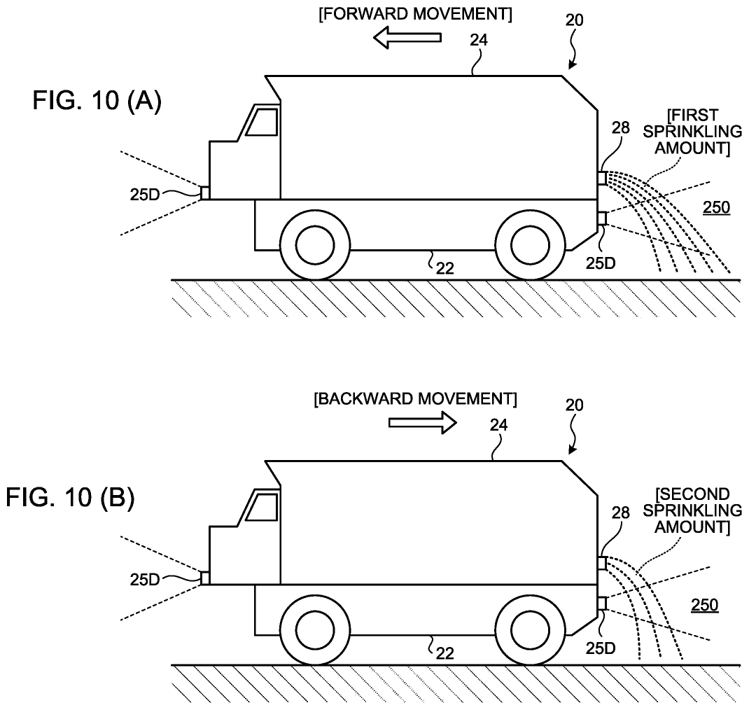

FIG. 10 is a diagram for explaining an operation of the unmanned sprinkling vehicle 20 according to the embodiment. In the above-described embodiment, the sprinkling control unit 82 controls the sprinkling spray 28 so that the sprinkling from the sprinkling spray 28 is executed when the unmanned sprinkling vehicle 20 moves forward, and the sprinkling spray 28 is stopped when the unmanned sprinkling vehicle 20 moves backward. The sprinkling control unit 82 may control the sprinkling spray 28 such that the sprinkling amount when the unmanned sprinkling vehicle 20 moves backward is smaller than the sprinkling amount when the unmanned sprinkling vehicle 20 moves forward. The sprinkling amount refers to the amount of water sprinkled per unit time from the sprinkling spray 28. As illustrated in FIG. 10(A), the sprinkling control unit 82 controls the sprinkling spray 28 so that the sprinkling spray 28 is sprinkled with the first sprinkling amount when the unmanned sprinkling vehicle 20 moves forward. As illustrated in FIG. 10(B), the sprinkling control unit 82 controls the sprinkling spray 28 so that the sprinkling spray 28 is sprinkled with the second sprinkling amount smaller than the first sprinkling amount when the unmanned sprinkling vehicle 20 moves backward.

Since the sprinkling amount from the sprinkling spray 28 when the unmanned sprinkling vehicle 20 moves backward is reduced, the tires 27 are suppressed from slipping when the unmanned sprinkling vehicle 20 moves backward, and the unmanned sprinkling vehicle 20 can travel smoothly. In addition, since the sprinkling amount from the sprinkling spray 28 is reduced, water sprayed from the sprinkling spray 28 is suppressed from being splashed on the obstacle sensor 25D. In addition, since the sprinkling amount from the sprinkling spray 28 is reduced, entry of water from the sprinkling spray 28 into the detection area 250 of the obstacle sensor 25D defined behind the obstacle sensor 25D is suppressed. Therefore, a decrease in detection accuracy of the obstacle sensor 25D is suppressed.

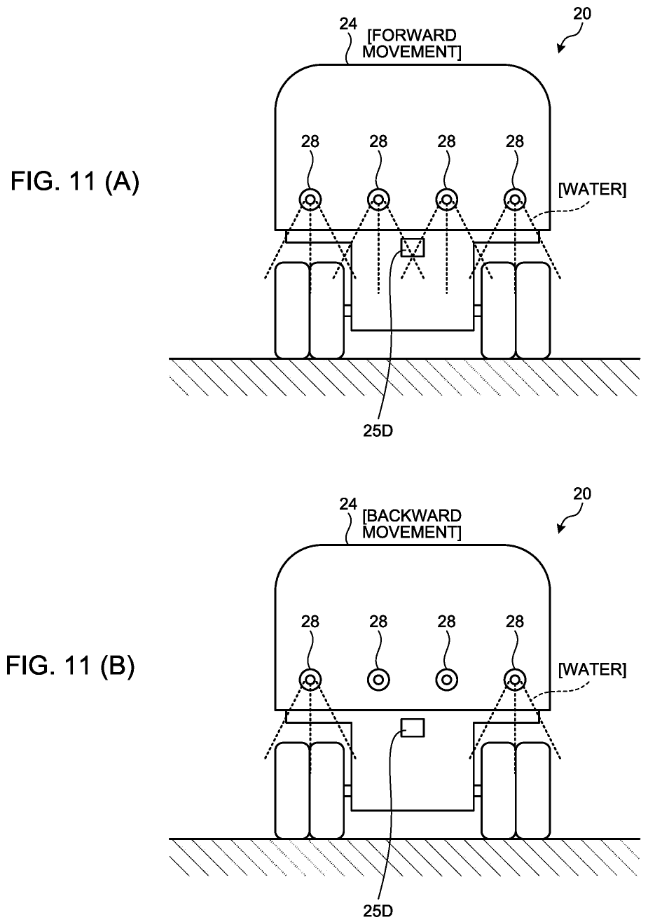

FIG. 11 is a diagram for explaining an operation of the unmanned sprinkling vehicle 20 according to the embodiment. As illustrated in FIG. 11, a plurality of sprinkling sprays 28 is provided at the rear portion of the unmanned sprinkling vehicle 20. The sprinkling spray 28 is installed at each of a plurality of positions in the rear portion of the unmanned sprinkling vehicle 20. In the example illustrated in FIG. 11, the plurality of sprinkling sprays 28 is arranged at intervals in the vehicle width direction at the rear portion of the unmanned sprinkling vehicle 20. The obstacle sensor 25D is disposed at the central portion in the vehicle width direction.

The sprinkling control unit 82 controls the sprinkling spray 28 so that the installation position of the sprinkling spray 28 that executes sprinkling when the unmanned sprinkling vehicle 20 moves backward is different from the installation position of the sprinkling spray 28 that executes sprinkling when the unmanned sprinkling vehicle 20 moves forward. In addition, the sprinkling control unit 82 controls the sprinkling spray 28 so that the number of the sprinkling spray 28 that executes sprinkling when the unmanned sprinkling vehicle 20 moves backward is smaller than the number of the sprinkling spray 28 that executes sprinkling when the unmanned sprinkling vehicle 20 moves forward.

The sprinkling control unit 82 controls the sprinkling spray 28 so that water from the sprinkling spray 28 does not enter the detection area 250 of the obstacle sensor 25D defined behind the obstacle sensor 25D. As illustrated in FIG. 11(A), the sprinkling control unit 82 controls the sprinkling spray 28 so that all the sprinkling spray 28 is sprinkled when the unmanned sprinkling vehicle 20 moves forward. As illustrated in FIG. 11(B), the sprinkling control unit 82 controls the sprinkling spray 28 so that the sprinkling from the sprinkling spray 28 separated from the obstacle sensor 25D by the first distance is stopped and the sprinkling spray 28 separated from the obstacle sensor 25D by the second distance longer than the first distance is sprinkled when the unmanned sprinkling vehicle 20 moves backward. In the example illustrated in FIG. 11(B), four sprinkling sprays 28 are arranged in the vehicle width direction, and the spray from two sprinkling sprays 28 installed immediately above the obstacle sensor 25D is stopped, and the spray from two sprinkling sprays 28 installed at the end portion in the vehicle width direction is executed.

Since the number of sprinkling sprays 28 sprinkled when the unmanned sprinkling vehicle 20 moves backward is smaller than the number of sprinkling sprays 28 sprinkled when the unmanned sprinkling vehicle 20 moves forward, the tires 27 are suppressed from slipping when the unmanned sprinkling vehicle 20 moves backward. Therefore, the unmanned sprinkling vehicle 20 can travel smoothly. In addition, by stopping sprinkling from the sprinkling spray 28 installed near the obstacle sensor 25D, it is possible to suppress water sprayed from the sprinkling spray 28 from splashing the obstacle sensor 25D or water from the sprinkling spray 28 from entering the detection area 250 of the obstacle sensor 25D. Therefore, a decrease in detection accuracy of the obstacle sensor 25D is suppressed.

In the embodiment described above, the obstacle sensor 25D is disposed below the sprinkling spray 28. The obstacle sensor 25D may be disposed above the sprinkling spray 28 or may be disposed on the side of the sprinkling spray 28. In a case where the obstacle sensor 25D is disposed above the sprinkling spray 28 or in a case where the obstacle sensor 25D is disposed on the side of the sprinkling spray 28, there is a possibility that water from the sprinkling spray 28 enters the detection area 250 of the obstacle sensor 25D. Therefore, even in a case where the obstacle sensor 25D is disposed above the sprinkling spray 28 or in a case where the obstacle sensor 25D is disposed on the side of the sprinkling spray 28, the sprinkling from the sprinkling spray 28 is stopped when the unmanned sprinkling vehicle 20 moves backward, so that a decrease in detection accuracy of the obstacle sensor 25D is suppressed.

In the above-described embodiment, the sprinkling spray 28 is provided at the rear portion of the unmanned sprinkling vehicle 20. The sprinkling spray 28 may be provided at the front portion of the unmanned sprinkling vehicle 20, and the sprinkling spray 28 may be sprinkled toward the front of the unmanned sprinkling vehicle 20. In a case where the sprinkling spray 28 is provided at the front portion of the unmanned sprinkling vehicle 20 and the sprinkling spray 28 is sprinkled toward the front side of the unmanned sprinkling vehicle 20, the sprinkling control unit 82 controls the sprinkling spray 28 so that water is sprinkled from the sprinkling spray 28 when the unmanned sprinkling vehicle 20 moves backward and the sprinkling from the sprinkling spray 28 is stopped when the unmanned sprinkling vehicle 20 moves forward. As a result, the tires 27 are suppressed from slipping when the unmanned sprinkling vehicle 20 moves forward, and the unmanned sprinkling vehicle 20 can travel smoothly. In addition, in a case where the obstacle sensor 25D is provided in the front portion of the unmanned sprinkling vehicle 20, it is suppressed that the water sprayed from the sprinkling spray 28 is splashed on the obstacle sensor 25D provided in the front portion of the unmanned sprinkling vehicle 20 or enters the detection area 250 of the obstacle sensor 25D, so that a decrease in detection accuracy of the obstacle sensor 25D is suppressed.

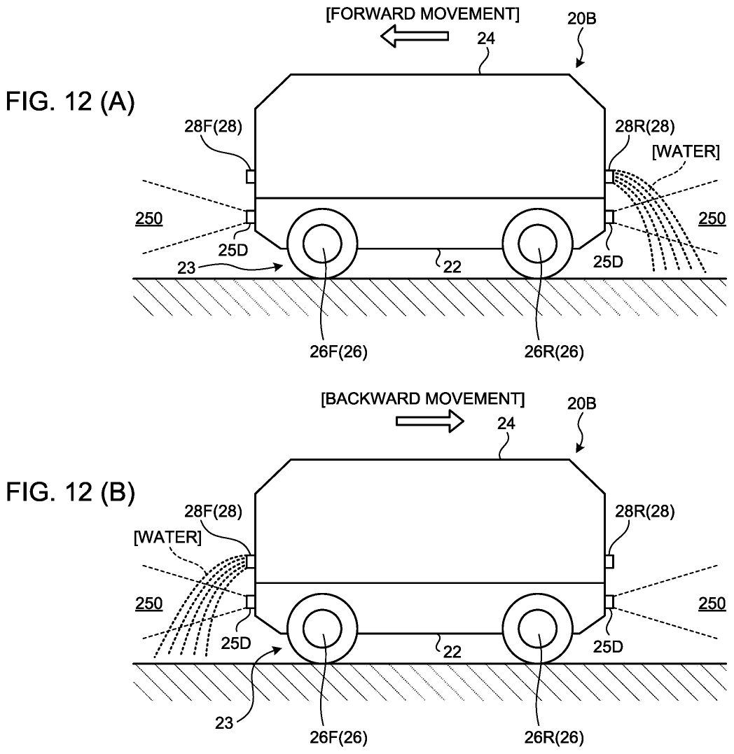

FIG. 12 is a diagram for explaining an operation of an unmanned sprinkling vehicle 20B according to the embodiment. The unmanned sprinkling vehicle 20B is a cabless sprinkling truck having no cab. The outer shape of the front portion and the outer shape of the rear portion of the unmanned sprinkling vehicle 20B are substantially equal. The unmanned sprinkling vehicle 20B moves forward and backward. Each of the front wheels 26F and the rear wheels 26R is a steering wheel. Each of the front wheels 26F and the rear wheels 26R is a driving wheel. The traveling performance of the unmanned sprinkling vehicle 20B when moving forward is substantially the same as the traveling performance of the unmanned sprinkling vehicle 20B when moving backward. That is, the driving performance, the braking performance, and the turning performance of the traveling device 23 at the time of forward movement are substantially the same as the driving performance, the braking performance, and the turning performance of the traveling device 23 at the time of backward movement. For example, the maximum traveling speed of the unmanned sprinkling vehicle 20B at the time of forward movement is substantially the same as the maximum traveling speed of the unmanned sprinkling vehicle 20B at the time of backward movement. The maximum acceleration of the unmanned sprinkling vehicle 20B at the time of forward movement is substantially the same as the maximum acceleration of the unmanned sprinkling vehicle 20B at the time of backward movement.

In the example illustrated in FIG. 12, the sprinkling spray 28 is provided at each of the front portion and the rear portion of the unmanned sprinkling vehicle 20B. In the example illustrated in FIG. 12, the sprinkling spray 28 includes a sprinkling spray 28R provided at a first portion on the rear side of the unmanned sprinkling vehicle 20B and a sprinkling spray 28F provided at a third portion on the front side of the unmanned sprinkling vehicle 20B. In addition, the obstacle sensor 25D is provided at each of the front portion and the rear portion of the unmanned sprinkling vehicle 20B.

The sprinkling control unit 82 controls the sprinkling spray 28R such that the sprinkling condition of the sprinkling spray 28R when the unmanned sprinkling vehicle 20B travels to one side in the traveling direction is different from the sprinkling condition of the sprinkling spray 28R when the unmanned sprinkling vehicle 20B travels to the other side in the traveling direction. In addition, the sprinkling control unit 82 controls the sprinkling spray 28F so that the sprinkling condition of the sprinkling spray 28F when the unmanned sprinkling vehicle 20B travels to the other side in the traveling direction is different from the sprinkling condition of the sprinkling spray 28F when the unmanned sprinkling vehicle 20B travels to one side in the traveling direction.

That is, for the sake of convenience, in a case where traveling of the unmanned sprinkling vehicle 20B to one side in the traveling direction is referred to as backward movement and traveling of the unmanned sprinkling vehicle 20B to the other side in the traveling direction is referred to as forward movement, the sprinkling control unit 82 controls the sprinkling spray 28R so that the sprinkling condition of the sprinkling spray 28R when the unmanned sprinkling vehicle 20B moves backward is different from the sprinkling condition of the sprinkling spray 28R when the unmanned sprinkling vehicle 20B moves forward. The sprinkling control unit 82 controls the sprinkling spray 28F so that the sprinkling condition of the sprinkling spray 28F when the unmanned sprinkling vehicle 20B moves forward is different from the sprinkling condition of the sprinkling spray 28F when the unmanned sprinkling vehicle 20B moves backward.

As illustrated in FIG. 12(A), the sprinkling control unit 82 controls each of the sprinkling spray 28F and the sprinkling spray 28R such that water is sprinkled from the sprinkling spray 28R when the unmanned sprinkling vehicle 20B moves forward, and the sprinkling from the sprinkling spray 28F is stopped.

As illustrated in FIG. 12(B), the sprinkling control unit 82 controls each of the sprinkling spray 28F and the sprinkling spray 28R such that water is sprinkled from the sprinkling spray 28F and the sprinkling from the sprinkling spray 28R is stopped when the unmanned sprinkling vehicle 20B moves backward.

Note that the sprinkling control unit 82 may control the sprinkling spray 28F so that the sprinkling spray 28F is sprinkled with the first sprinkling amount when the unmanned sprinkling vehicle 20B moves backward, and the sprinkling spray 28F is sprinkled with the second sprinkling amount smaller than the first sprinkling amount when the unmanned sprinkling vehicle 20B moves forward. In addition, in a case where a plurality of sprinkling sprays 28F is provided, the sprinkling control unit 82 may control the sprinkling spray 28F so that the number of sprinkling sprays 28F that execute sprinkling when the unmanned sprinkling vehicle 20B moves forward is smaller than the number of sprinkling sprays 28F that execute sprinkling when the unmanned sprinkling vehicle 20B moves backward. In addition, the sprinkling control unit 82 may control the sprinkling spray 28F so that the installation position of the sprinkling spray 28F that executes sprinkling when the unmanned sprinkling vehicle 20B moves backward is different from the installation position of the sprinkling spray 28F that executes sprinkling when the unmanned sprinkling vehicle 20B moves forward.

In addition, the sprinkling control unit 82 may control the sprinkling spray 28R so that the sprinkling spray 28R is sprinkled with the first sprinkling amount when the unmanned sprinkling vehicle 20B moves forward, and the sprinkling spray 28R is sprinkled with the second sprinkling amount smaller than the first sprinkling amount when the unmanned sprinkling vehicle 20B moves backward. In addition, in a case where a plurality of sprinkling sprays 28R is provided, the sprinkling control unit 82 may control the sprinkling spray 28R such that the number of sprinkling sprays 28R that execute sprinkling when the unmanned sprinkling vehicle 20B moves backward is smaller than the number of sprinkling sprays 28R that execute sprinkling when the unmanned sprinkling vehicle 20B moves forward. In addition, the sprinkling control unit 82 may control the sprinkling spray 28R such that the installation position of the sprinkling spray 28R that executes sprinkling when the unmanned sprinkling vehicle 20B moves forward is different from the installation position of the sprinkling spray 28R that executes sprinkling when the unmanned sprinkling vehicle 20B moves backward.

As a result, the tires 27 are suppressed from slipping when the unmanned sprinkling vehicle 20B moves forward and backward, and the unmanned sprinkling vehicle 20B can travel smoothly.

In addition, when the unmanned sprinkling vehicle 20B moves forward and backward, a decrease in detection accuracy of the obstacle sensor 25D provided in each of the front portion and the rear portion of the unmanned sprinkling vehicle 20 is suppressed.

In the above-described embodiment, at least a part of the function of the control device 11 and the function of the control device 21 may be provided in the management device 2, or at least a part of the function of the management device 2 may be provided in one or both of the control device 11 and the control device 21. For example, in the above-described embodiment, the management device 2 may have the function of the sprinkling control unit 82. The control device 21 may have the function of the course data generation unit 61 and the function of the sprinkling data generation unit 62.

In the above-described embodiment, each of the course data generation unit 61, the sprinkling data generation unit 62, and the output unit 63 may be configured by separate hardware. Each of the travel control unit 81 and the sprinkling control unit 82 may be configured by separate hardware.

### REFERENCE SIGNS LIST

1 MANAGEMENT SYSTEM
2 MANAGEMENT DEVICE
3 COMMUNICATION SYSTEM
3A WIRELESS COMMUNICATION DEVICE
3B WIRELESS COMMUNICATION DEVICE
3C WIRELESS COMMUNICATION DEVICE
4 CONTROL FACILITY
5 LOADER
6 CRUSHER
7 OIL FEEDER
8 WATER SUPPLIER
9 INPUT DEVICE
10 UNMANNED HAUL VEHICLE
11 CONTROL DEVICE
20 UNMANNED SPRINKLING VEHICLE (SPRINKLING VEHICLE)
20B UNMANNED SPRINKLING VEHICLE (SPRINKLING VEHICLE)
21 CONTROL DEVICE
22 VEHICLE BODY
23 TRAVELING DEVICE
24 TANK
25 SENSOR SYSTEM
25A POSITION SENSOR
25B AZIMUTH SENSOR
25C SPEED SENSOR
25D OBSTACLE SENSOR
26 WHEEL
26F FRONT WHEEL
26R REAR WHEEL
27 TIRE
27F FRONT TIRE
27R REAR TIRE
28 SPRINKLING SPRAY
28F SPRINKLING SPRAY
28R SPRINKLING SPRAY
29 CAB
31 LOADING AREA
32 DISCHARGING AREA
33 PARKING AREA
34 FUEL FILLING AREA
35 WATER SUPPLY AREA
36 TRAVEL PATH
37 INTERSECTION
41 COMMUNICATION INTERFACE
42 STORAGE CIRCUIT
43 PROCESSING CIRCUIT
51 SPRINKLING CONDITION STORAGE UNIT
61 COURSE DATA GENERATION UNIT
62 SPRINKLING DATA GENERATION UNIT
63 OUTPUT UNIT
81 TRAVEL CONTROL UNIT
82 SPRINKLING CONTROL UNIT
100 CONTROL SYSTEM
102 TRAVEL COURSE
201 COURSE POINT
202 TRAVEL COURSE
250 DETECTION AREA

1. A sprinkling vehicle control system comprising:
a travel control unit that switches a traveling direction of a sprinkling vehicle; and
a sprinkling control unit that controls a first sprinkling spray provided at a first portion on one side in a traveling direction in the sprinkling vehicle,
wherein the sprinkling control unit controls the first sprinkling spray such that a sprinkling condition of the first sprinkling spray when the sprinkling vehicle travels to the one side in the traveling direction is different from a sprinkling condition of the first sprinkling spray when the sprinkling vehicle travels to another side in the traveling direction.

2. The sprinkling vehicle control system according to claim 1,
wherein the sprinkling condition includes execution of sprinkling and stop of sprinkling by the first sprinkling spray, and
the sprinkling control unit controls the first sprinkling spray such that the sprinkling from the first sprinkling spray is stopped when the sprinkling vehicle travels to the one side in the traveling direction.

3. The sprinkling vehicle control system according to claim 1,
wherein the sprinkling condition includes a sprinkling amount from the first sprinkling spray, and
the sprinkling control unit controls the first sprinkling spray such that the sprinkling amount when the sprinkling vehicle travels to the one side in the traveling direction is smaller than the sprinkling amount when the sprinkling vehicle travels to the other side in the traveling direction.

4. The sprinkling vehicle control system according to claim 1,
wherein a plurality of the first sprinkling spray is provided,
the sprinkling condition includes a number of the first sprinkling spray that executes sprinkling, and
the sprinkling control unit controls the first sprinkling spray such that the number of the first sprinkling spray that executes sprinkling when the sprinkling vehicle travels to the one side in the traveling direction is smaller than the number of the first sprinkling spray that executes sprinkling when the sprinkling vehicle travels to the other side in the traveling direction.

5. The sprinkling vehicle control system according to claim 1,
wherein the first sprinkling spray is installed at each of a plurality of positions,
the sprinkling condition includes an installation position of the first sprinkling spray that executes sprinkling, and
the sprinkling control unit controls the first sprinkling spray such that the installation position of the first sprinkling spray that executes sprinkling when the sprinkling vehicle travels to the one side in the traveling direction is different from the installation position of the first sprinkling spray that executes sprinkling when the sprinkling vehicle travels to the other side in the traveling direction.

6. The sprinkling vehicle control system according to claim 1,
wherein the travel control unit switches the traveling direction of the sprinkling vehicle based on course data defining the traveling direction of the sprinkling vehicle, and
the sprinkling control unit controls the first sprinkling spray based on the course data.

7. The sprinkling vehicle control system according to claim 1,
wherein the sprinkling vehicle includes a wheel and a sensor that detects a rotation direction of the wheel, and
the sprinkling control unit controls the first sprinkling spray based on detection data of the sensor.

8. The sprinkling vehicle control system according to claim 1,
wherein an obstacle sensor is provided at a second portion on the one side in the traveling direction in the sprinkling vehicle, and
the sprinkling control unit controls the first sprinkling spray such that water from the first sprinkling spray does not enter a detection area of the obstacle sensor.

9. The sprinkling vehicle control system according to claim 1,
wherein the first sprinkling spray is provided at a rear portion of the sprinkling vehicle, and
the sprinkling control unit controls the first sprinkling spray such that the sprinkling from the first sprinkling spray is executed when the sprinkling vehicle moves forward, and the sprinkling from the first sprinkling spray is stopped when the sprinkling vehicle moves backward.

10. The sprinkling vehicle control system according to claim 1,
wherein a second sprinkling spray is provided at a third portion on the other side in the traveling direction in the sprinkling vehicle, and
the sprinkling control unit controls the second sprinkling spray such that a sprinkling condition of the second sprinkling spray when the sprinkling vehicle travels to the other side in the traveling direction is different from a sprinkling condition of the second sprinkling spray when the sprinkling vehicle travels to the one side in the traveling direction.

11. A sprinkling vehicle comprising
the sprinkling vehicle control system according to claim 1.

12. A sprinkling vehicle control method comprising:
controlling a first sprinkling spray provided at a first portion on one side in a traveling direction of a sprinkling vehicle to satisfy a first sprinkling condition when the sprinkling vehicle travels to the one side in the traveling direction; and
controlling the first sprinkling spray to satisfy a second sprinkling condition different from the first sprinkling condition when the sprinkling vehicle travels in another side in the traveling direction.
